(19) United States
(12) Patent Application Publication
(10) Pub. No.: US 2006/0103254 A1
(43) Pub. Date: May 18, 2006

(54) Permanent magnet rotor

(76) Inventor: Gary E. Horst, Manchester, MO (US)

Correspondence Address: HARNESS, DICKEY, & PIERCE, P.L.C, 7700 BONHOMME, STE 400, ST. LOUIS, MO, 63105, US

(21) Appl. No.: 10/990,115

(22) Filed: Nov. 16, 2004

(51) Int. Cl. H02K 21/12; H02K 1/27

(52) U.S. Cl. 310/156.53

(57) ABSTRACT

A rotor for an electric machine has a rotor core with a plurality poles and a method of magnetizing the poles of a rotor. At least one of the poles includes a plurality of cavities spaced radially from one another with each of the cavities having a magnet portion. Each of a plurality of block magnets has substantially the same width and is positioned within one of the magnet portions of the cavities.

### FIELD OF THE INVENTION

The present invention relates to an electric machine and more specifically relates to a rotor for an electric machine having permanent magnets.

### BACKGROUND OF THE INVENTION

A wide variety of electric machines are known in which a plurality of magnets are positioned on or within a core to form a rotor for an electric machine such as an electric motor, electric generator, or dynamoelectric machine. The rotor core can be formed from a solid magnetically conductive material or can be formed from a plurality of plates of magnetically conducting material laminated to form a particular rotor stack height.

Various techniques are known for positioning the magnets on or within the core. Magnets are positioned on or within the body of the rotor to define a plurality of alternating North and South magnetized or biased rotor poles. Typically, cavities are created in the rotor core body to define each of the rotor poles. Each pole is can be defined by one or more of these cavities that includes layers of cavities. The cavities often have a complex shape aimed at maximizing the magnetic force associated with each pole while also ensuring structural integrity of the rotor during high speed operation. In a multiple cavity pole design, the cavity for each layer of a pole has a different dimension and can have a different shape.

As such, magnets that are to be inserted into the rotor core cavities also have a complex shape that corresponds with the complex shapes of the rotor core cavities. Where there are multiple cavities formed in multiple layers, the magnets for insertion in each cavity and each layer typically have different dimensions. The magnets are inserted into the cavities defining each rotor pole such that each pole defines an alternating North and South pole arrangement around the perimeter of the rotor core. As the rotor core is formed from magnetically conducting material, the insertion of the magnets into the rotor cavities is often difficult and time consuming.

### SUMMARY OF THE INVENTION

The inventor of the present invention has succeeded at designing a rotor for electric machines (such as electric motors, generators, and other dynamoelectric machines). The rotor has cavities with block magnets positioned therein. The block magnets can be polarized or magnetized after insertion into the cavities. In many cases, these techniques can be readily applied to rotors having a variety of stack heights.

According to one aspect of the invention, a rotor for an electric machine has a rotor core with a plurality poles. At least one of the poles includes a plurality of cavities spaced radially from one another wherein each of the cavities includes a magnet portion. Each of a plurality of block magnets having substantially the same width are positioned within one of the magnet portions of the cavities.

According to another aspect of the invention, an electric machine includes a shaft, a stator having a plurality of stator poles surrounding a rotor cavity, and a rotor attached to the shaft and positioned within the rotor cavity. The rotor has a rotor core with a plurality poles. Each of the poles includes a plurality of pole cavities spaced radially from one another and each cavity has a magnet portion. At least one of a plurality of block magnets with substantially the same width are positioned within the magnet portion of each of the poles cavities.

According to yet another aspect of the invention, a method of magnetizing a rotor for an electric machine wherein the rotor is an inner rotor that is positioned about a shaft and includes a plurality of poles. The rotor includes one that has another pole positioned at 180 degrees on the rotor. A magnetizing flux is applied through the two poles positioned at 180 degrees and through the shaft such that the two poles are simultaneously magnetized to have opposite polarities.

According to still another aspect of the invention, a method of magnetizing a rotor for an electric machine where the rotor is an inner rotor with a plurality of poles and a rotor cavity. A first portion of a magnetizing device is positioned within the rotor cavity and a second portion of the magnetizing device is positioned external to a perimeter of the rotor. Magnetizing flux is applied individually to each of the poles.

Further aspects and features of the invention will be in part apparent and in part pointed out from the detailed description provided hereinafter. It should be understood that the detailed description and specific examples, while indicating some embodiments of the invention, are intended for purposes of illustration only and are not intended to limit the scope of the invention.

### BRIEF DESCRIPTION OF THE DRAWINGS

Embodiments of the invention will become more fully understood from the detailed description and the accompanying drawings.

FIG. 1 is a sectional view of a rotor core according to one embodiment of the invention.

FIG. 2 is an isometric view of a block magnet according to another embodiment of the invention.

FIG. 3 is a partial sectional view of block magnets positioned within a rotor core according to another embodiment of the invention.

FIG. 4A is an isometric view of a magnet according to another embodiment of the invention.

FIG. 4B is an isometric view of a sectional block magnet according to another embodiment of the invention.

FIG. 4C is an isometric view of a sectional block magnet with each section being separated by an insulating material according to another embodiment of the invention.

FIG. 5A is an isometric view of a rotor with single piece magnets according to one embodiment of the invention.

FIG. 5B is an isometric view of a rotor with monolithic magnets having segment and insulating portions according to another embodiment of the invention.

FIG. 6 is a sectional view of an electric machine having a rotor according to another embodiment of the invention.

FIG. 7 is a sectional view of simultaneously magnetizing two 180 degree opposing poles of a rotor according to another embodiment of the invention.

FIG. 8 is a sectional view of individually magnetizing a single pole of a rotor according to another embodiment of the invention.

FIGS. 9A, 9B, and 9C are sectional views of three exemplary embodiments of a magnetizing assembly for magnetizing a single pole of a rotor.

Corresponding reference characters indicate corresponding parts throughout the several views of the drawings. The following description is merely exemplary in nature and is in not intended to limit the invention, its applications, or uses.

### DETAILED DESCRIPTION OF PREFERRED EMBODIMENTS

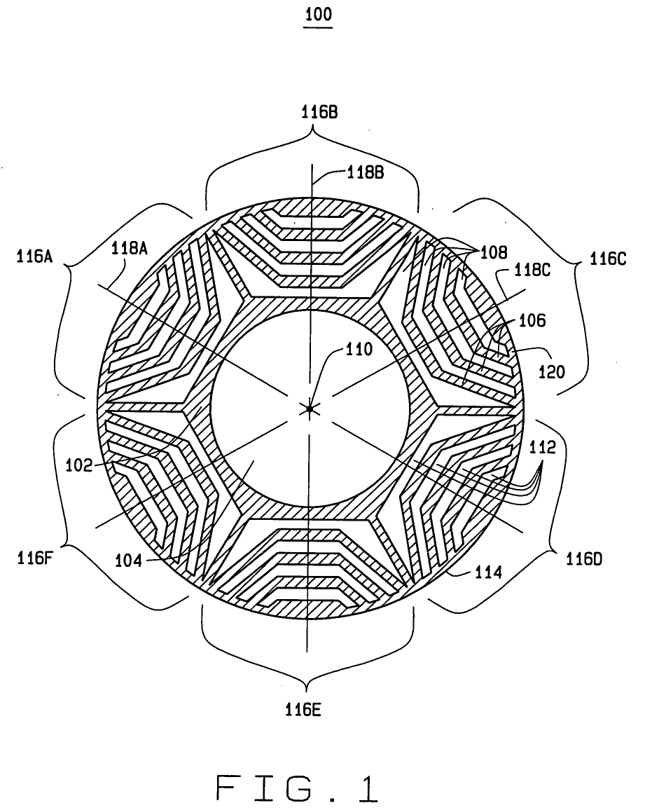

A core of a rotor for an electric machine is illustrated in FIG. 1 according to one exemplary embodiment of the invention. A rotor core 100 includes a core body 102 composed of a magnetically conductive material. The rotor core body 102 can be a single or monolithic body having a length defining a rotor length or can be a plurality of plates of conductive material that are laminated together to define the length of the rotor.

The rotor core body 102 has a center arbor 104 or cavity about a center axis 110 and a perimeter 114. The center arbor 104 provides for insertion of a shaft (not shown) or arbor for attachment to a shaft. In other embodiments, the center arbor 104 can be a shaft hole dimensioned for insertion of an electric machine shaft. The rotor core body 102 includes a plurality of cavities 108 and flux channels 106 formed by the rotor core body 102. The flux channels 106 separate the plurality of cavities 108 and define each of the plurality of rotor poles 116. Each of the cavities 108 and flux channels 106 extend from a radial position near their center to about the perimeter 114 of the rotor core body 102. In this exemplary embodiment, the rotor 100 has six rotor poles 116A-F. Each of the six rotor poles 116A-F is defined by a plurality of cavities 108. As illustrated, pole 116C is defined by four rotor cavities 108. The four rotor cavities 108 and the flux channels 106 define a bridge 120 along the perimeter 114 of the rotor 100. The bridges 120 provide structural integrity to the rotor 100. Each of the rotor cavities 108 includes a magnet portion 112. The magnet portion 112 of each cavity generally has a rectangular shape and can be dimensioned substantially the same as the magnet portions 112 of other cavities 108. As illustrated, the magnet portion 112 for each of the four cavities 108 of pole 116D has about the same rectangular shape, e.g., about the same width and about the same thickness. Each magnet portion 112 divides a cavity 108 into two open cavity portions on either side of the magnet portion 112. These open portions are referred herein to as flux barriers.

Each of the pluralities of cavities 108 defining a rotor pole 116 is positioned about a rotor pole center line 118 such that the center line 118 is about the center of a width of the magnet portion 112 As illustrated, the cavities can be positioned symmetrically about the pole center line 118.

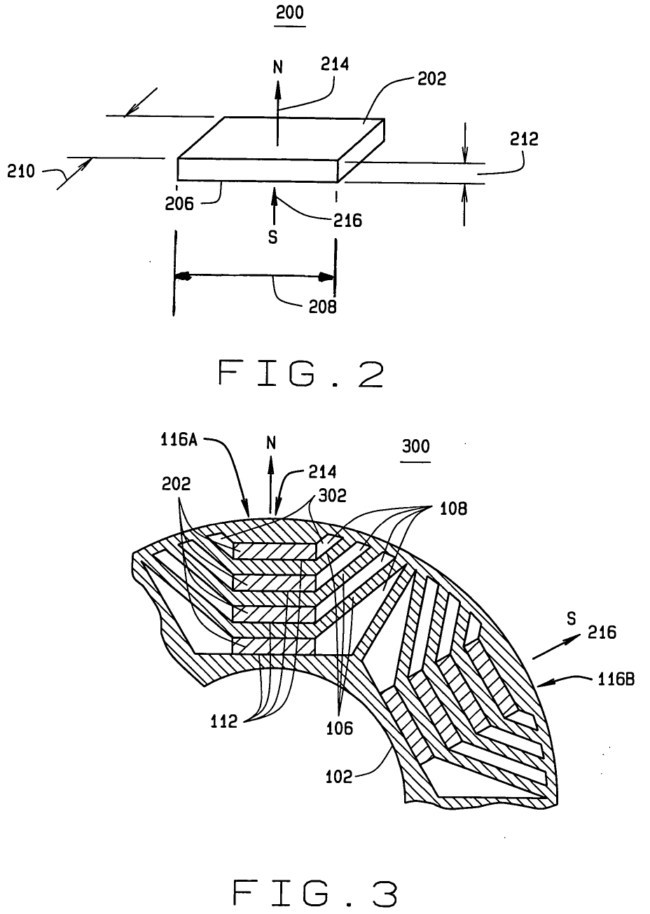

Referring to FIG. 2, a magnet 200 is formed from a magnet body 202. The magnet body 202 can be of any type of magnetic material, such as, by way of example, an iron, an iron-powder, a neo-magnetic material, a hardened alloy, a rare-earth metal, an AINiCo, a ferromagnet (ceramics), a sintered samarium cobalt (SmCo), a sintered NdFeB, or a bonded NdFeB. The magnet body 202 can be un-magnetized or magnetized magnetic material. The magnet body 202 is dimensioned as a rectangle or block having a top surface 204, a bottom surface 206, a length 208, a width 210, and a thickness 212. The magnets 200 are dimensioned for insertion into the magnet portions 112 of the cavities 108 defining the poles 116 in the rotor core body 102. In one preferred embodiment, each magnet 202 has substantially uniform flux density across the entire width 210 and length 208.

The magnet 200, when magnetized, includes a North magnetic pole 214 and a South magnetic pole 216. As illustrated, in the exemplary embodiment of FIG. 2, the North magnetic pole 214 can be generally defined by a magnetic force extending from the top surface 204 and the South magnetic pole 216 can by defined by magnetic force lines extending into the bottom surface 206. In another embodiment, the opposite magnetic North and South polarities are present.

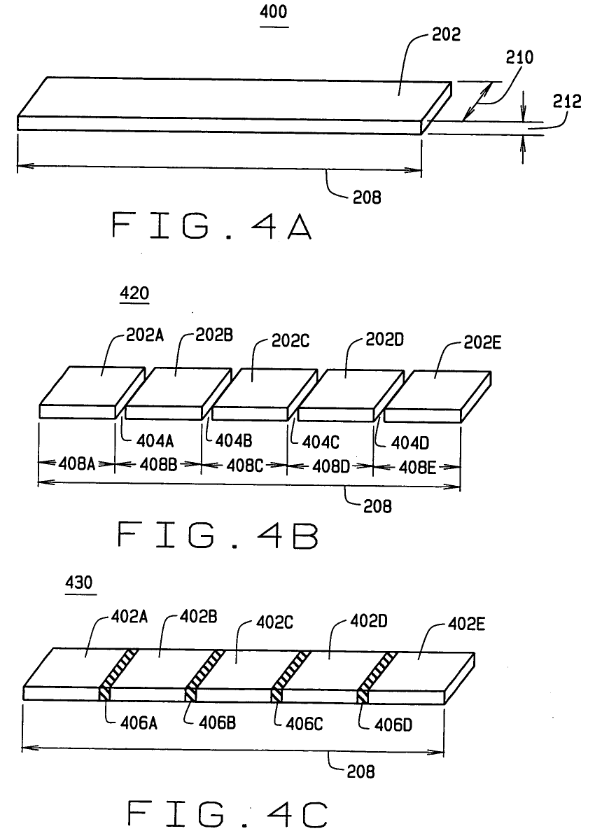

As shown in rotor core 300 of FIG. 3, the magnets 202 are positioned within the magnet portions 112 of the cavities 108. When the magnets 202 are positioned within the cavities 108, open portions 302 of the cavities 108 are defined on either side of the magnet 202. The open portions 302 act as flux barriers to the magnetic forces of the magnets 202 to direct the magnetic flux forces along flux channels 106. As such, the open cavities portions 302 and the flux channels 106 operate to shape the magnetic forces or flux lines of the magnets 202 thereby shaping the magnetic forces or flux lines of the rotor pole 116.

As illustrated in FIG. 3, while each of the layer cavities 108 defining a particular rotor pole such as the North polarized 214 rotor pole 116A has a different shape and a different size for defining the rotor pole 116A, the magnet portions 112 for each and every cavity 108 are substantially dimensioned the same. Additionally, each of the magnets 202 are substantially dimensioned the same and are dimensioned for insertion into the magnet portions 112 of the cavities 108. As such, each magnet portion 112 for any of the cavities 108, at any pole 116 or any layer of a particular pole can accepts any of the plurality of magnets 202. Therefore, the magnets 202 can be standardized and do not have to have particular or special design or dimensions, e.g., one size of magnet fits all magnet portions 112 of the rotor core cavities 108. The magnets 202 are inserted into the magnet portion 112 of cavity 108 and can be held in place with an adhesive material such as glue, epoxy, or a bonding agent (not shown).

In one preferred embodiment, each pole 116 includes at least two layers of cavities 108. Two magnets 202 having a block shape are positioned within the two layered cavities 108 and are positioned such that their magnet fields are aligned and cooperate to provide either an outwardly North or South magnet field to the rotor pole 116. In one preferred embodiment, each of the magnets 202 has substantially uniform flux density across the width of the magnet 202. In another preferred embodiment, the magnetic force or flux lines of each magnet 202 are substantially parallel to a single radius extending from the center of the rotor 300 and about the center of the width of the magnet 202.

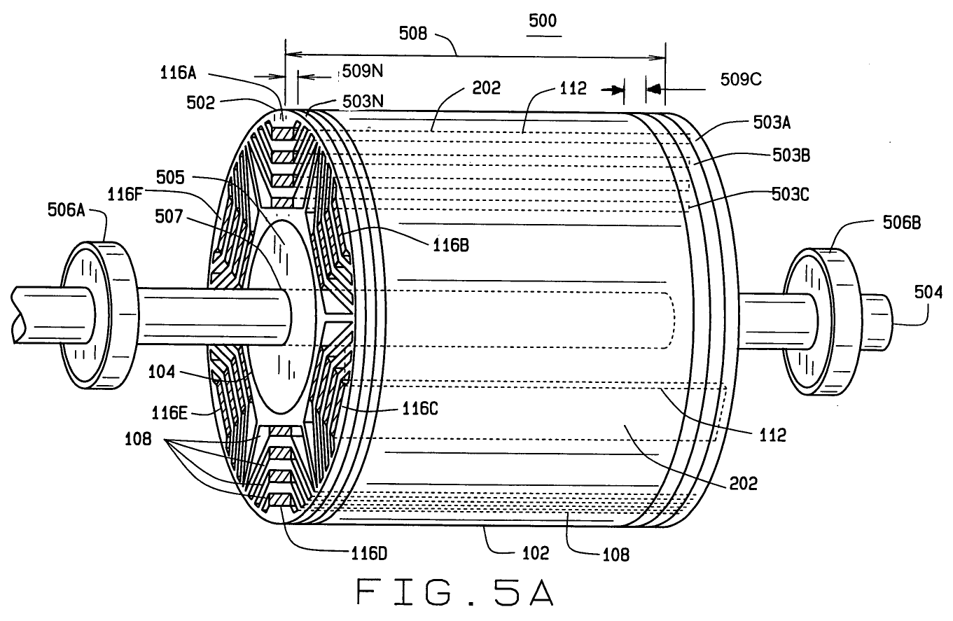

As discussed above, a rotor 100 has a particular rotor length. Each cavity 108 of the rotor 100 has this same length and accepts the insertion of the magnet 202. As such, each magnet 202 has a magnet length 208 that is substantially equal to the rotor length. As illustrated in FIG. 4A, magnet 202 can be a single magnet portion 400 having a length 208 which can be substantially equivalent to the rotor length. The magnet 202 has a width 210 and thickness 212 dimensioned for insertion of the magnet 202 into the magnet portion 112 of cavity 108.

In another embodiment as illustrated in FIG. 4B, the magnet 202 includes a plurality of magnet segments 402 each having a segment length 408. As illustrated, each of the five magnet segments 402A-E has a segment length of 408A-E. As positioned together and separated by a segment gap or space 404, the total magnet length is the magnet length 208. The gap 404 can be an air gap or can be a gap filled with an insulting or separating gas, liquid, or solid. For example, the gap insulating material can include paper insulating material, a plastic, a nylon, a composite, or non-magnetic or non-conductive material.

When combined together in a particular end-to-end arrangement, the plurality of segments 402 has a combined segmented magnet length equal to magnet length 208. In some embodiments, the segmented magnet 208 can provide an electric machine manufacturer the ability to standardize on predetermined magnet or segment lengths and/or the assembly of varying length rotors through utilizing a different number of magnet segments 402. In the alternative, the segmented magnet 208 can provide for reduced surface and/or eddy currents for the plurality of magnets 208 of a magnet 202. Reduced surface or eddy currents can be desirable as the currents within or on the surface of the magnet 202 reduce the field flux or field intensity generated by the magnet 202 and therefore the field intensity of the rotor pole 116. While the exemplary embodiment of FIG. 4B illustrates a segmented magnet 420 having five magnet segments 402A-E, in other embodiments segmented magnet 420 can include any plurality of magnet segments equal to or greater than two.

In another embodiment, the magnet 202 is a monolithic magnet with conductive segments 430 as illustrated in FIG. 4C. In such an embodiment, a plurality of magnet segments 402 having segment lengths of 408A-E are separated by insulating portions or sections 406A-D. As with the segmented magnet 420 of FIG. 4B, each magnet segment 402 is electrically isolated from another segment 402 thereby providing for reduced surface currents across the surface of magnet 202 while enabling the insertion of a single magnet 202 into the magnet portion 112 of the cavity 108. The monolithic magnet with conductive segments 430 has a length from each of the segmented segments 402A-E and the length of each insulating portions 406A-D equal to the magnet length 208. The insulating portions 406 can be composed of any type of electrical insulating material or composition. The insulating portion 406 can be composed of nylon, a plastic, or a composite, by way of example. While the exemplary embodiment of FIG. 4C illustrates monolithic magnet with conductive segments 430 having five magnet segments 402A-E and four insulating portions 406A-D, in other embodiments monolithic magnet with conductive segments 430 can include any plurality of magnet segments 402 equal to or greater than two.

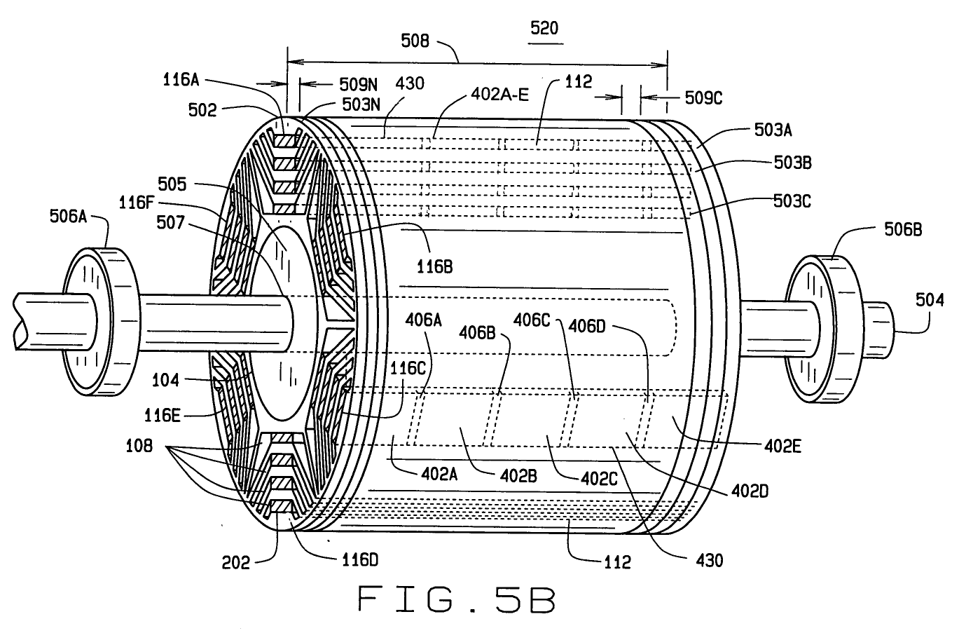

Referring now to FIG. 5A, an assembled rotor 500 is illustrated having the block magnets 202 of FIG. 4A. The rotor 500 is illustrated as one exemplary embodiment having a rotor core body 102 configured from a lamination of a plurality of rotor core body plates 503. The rotor core body 102 has a rotor length 508 that is defined by the plurality of the plates 503 A-N each having a plate or lamination thickness of 509 A-N. As such, rotors of various rotor lengths 508 can be assembled dependent on the number of laminated plates 503.

In this exemplary embodiment, each of the plates 503 A-N and therefore the rotor core body 102 includes six rotor poles 116A-F. Each of the rotor poles 116 is defined by a plurality of cavities 108. As shown, each rotor pole 116 is defined by four layers of cavities 108 with each having a magnet portion 112 having substantially the same width and thickness. A plurality of magnets 202 having a length substantially equivalent to the rotor length 508 are positioned within each of the magnet portions 112 of the cavities 108. While FIG. 5A illustrates one exemplary embodiment of the rotor 102 having each rotor pole 116 defined by four radially layered cavities 108 with four radially layered magnets 202, in other embodiments each pole 116 can be defined by two or more radially layered cavities 108. For example, in one preferred embodiment, each pole 116 has three magnet 202 positioned within three radially layered cavities 108.

The plates 503 define an arbor cavity 104. As illustrated, an arbor 505 is positioned with the arbor cavity 104 and includes a shaft cavity or hole 507. The arbor 505 and rotor core body assembly can be assembled onto a shaft 504 supported for rotational movement by bearings 506A and B. In other embodiments, the plates 503 can include a shaft hole 507 and not require the arbor cavity 104 or the arbor 505.

Another embodiment of an assembled rotor is illustrated as rotor assembly 520 in FIG. 5B. In this exemplary embodiment, each pole 116 is defined by four radially layered cavities 108 with four radially layered magnet portions 112. A monolithic magnet with conductive segments 430 is positioned within each of the magnet portions 112 of the cavities 108. Each monolithic magnet with conductive segments 430 has five segments 402A-E, each of which are electrically separated by an insulating portion 406. As illustrated, monolithic magnet with conductive segments 430 have a length about equal to rotor length 508. As previously noted, in another embodiment the magnets can be segmented magnet 420 as illustrated in FIG. 4B.

In other embodiments of the invention, a rotor assembly has a segmented magnet 202 such as magnet 420 or monolithic magnet with conductive segments 430 in a single cavity 108 of each rotor pole 108. The other magnets 202 of the other cavities 108 of the rotor pole 108 are non-segmented single magnets such as magnet 400 of FIG. 4A. In one preferred embodiment, each rotor pole 108 defined by a plurality of radially layered cavities 108 has a segmented magnet such as magnet 420 or monolithic magnet with conductive segments 430 positioned in the outer most cavity (108), e.g., the cavity closest to the rotor perimeter 114. The other magnets 202 of each pole are single non-segmented magnets 400.

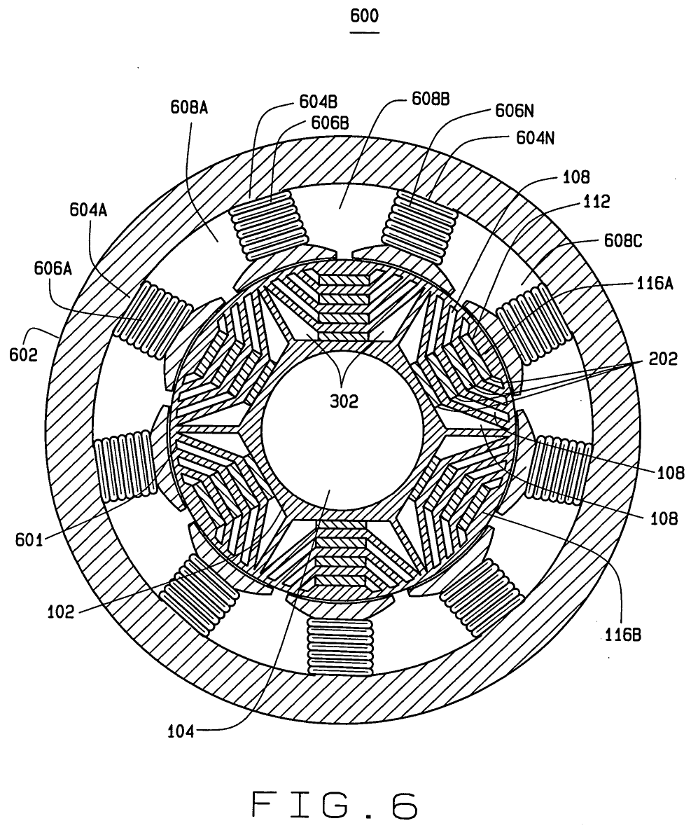

Referring now to FIG. 6, an electric machine 600 includes a rotor 601 with a rotor body 102 with an arbor cavity 104. The exemplary rotor 601 has six rotor poles 116 each of which is defined by four radially layered cavities 108. While each of the radially layered cavities 108 has a different design, shape, and dimensions, each has a substantially equivalent dimensioned magnet portion 112. The magnets 202 are positioned in the magnet portions 112 thereby defining a flux barrier in the cavities 108 on either side of the magnets 202. Each of the magnets 202 of the radially layered magnet portions 112 has substantially the same width and substantially the same thickness.

A stator body 602 defines a cavity such that the stator body surrounds the rotor 601. The stator body 602 defines a plurality of stator poles 604A-N separated by stator pole gaps 608A-N. In the illustrated exemplary embodiment of FIG. 6, the stator poles 604 are electromagnetic poles that include stator pole wire windings 606 A-N that, when energized, create the magnetic stator pole. During operation of the electric machine 600, the stator poles 604 magnetically interact with the rotor poles 116 to provide rotational energy to the rotor 601.

In another embodiment of the invention, a rotor is assembled having a plurality of non-magnetized magnets positioned within the plurality of cavities of a rotor body. The non-magnetized magnets or magnet portions are inserted into the cavities thereby providing for easier installation into the magnetically conducting rotor body. The non-magnetized magnets can be fixed into position within the cavity such as a block magnet portion of the cavity, with a bonding or adhesive material such as glue or epoxy, by way of example. After the non-magnetized magnets are positioned within each of the rotor cavities for each of the rotor poles, a magnetization force is applied to each of the magnets and to each of the poles to produce radially alternating North and South magnetized rotor poles.

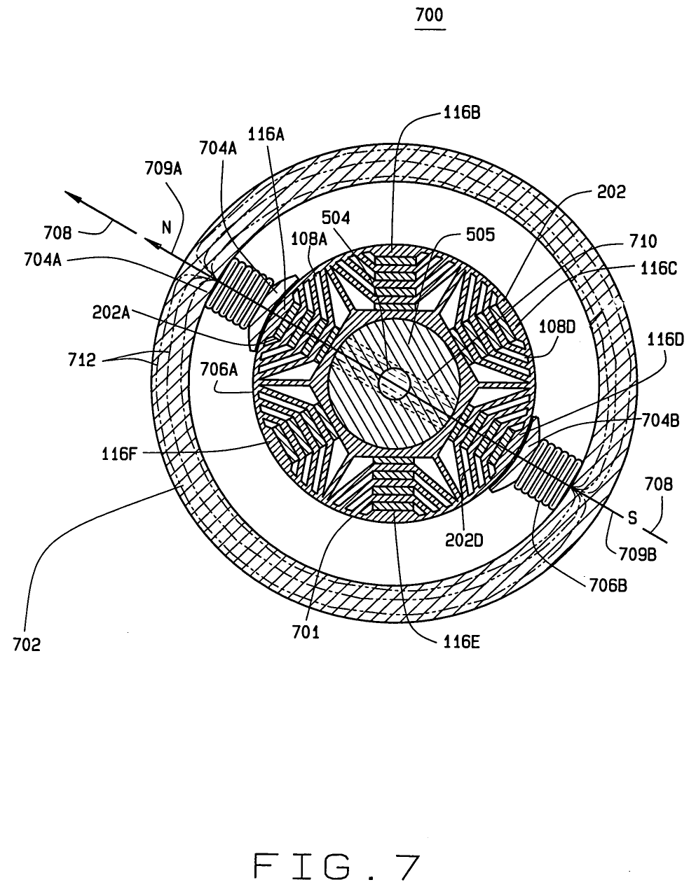

Referring now to FIG. 7, in one embodiment of magnetizing a rotor for an electric machine, the rotor 701 includes a plurality of rotor poles 116 such that each pole has an opposing pole at 180 degrees. As shown, the rotor pole 116A is 180 degrees from rotor pole 116D. Further, rotor 701 has a plurality of rotor poles 116 such that each set of 180 degree opposing poles is of an opposite polarity, e.g., one being North polarity and the other being South polarity. For example, the number of rotor poles equals the sum of two plus a product of four times N, with N being an integer equal to or greater than one. Another method for determining the number of poles is the product of the sum of N times plus three and two (the number of poles=(3+(N*2))*2), wherein N is an integer equal to or greater than zero. Generally, the number of poles can be 6, 10, 14, 18, 22, 26, 30, etc. The rotor poles 116 include a plurality of non-magnetized magnets 202 positioned in a plurality of rotor pole cavities 108. In one preferred embodiment, magnets 202 are substantially block-shaped magnets each of which is aligned perpendicular (as a tangent) to a radius extending from a center of the rotor 701. The magnets 202 may be of any magnetic material and in one preferred embodiment, the magnet 202 is a neo-magnetic material. In another embodiment, the non-magnetized magnets 202 may be an injected magnetic material.

The rotor 701 includes a center arbor 505 and a shaft 504, each of which is a magnetically conducting material such as a metal or a composite, by way of example.

A dual rotor magnetizing assembly 702 has two 180 degree opposing magnetizing electro-magnets 704A and 704B. Each of the opposing magnetizing electro-magnets 704A and 704B are dimensioned such that a consistent magnetizing force or flux is applied across the entire length of rotor 701 and entire length of magnets 202A and 202D.

Each of the magnetizing electromagnets 704A and B include a magnetizing winding 706A and B that receives an electric energy (not shown) and produces a magnetizing force or magnetizing flux from the magnetizing magnets 704. When energized, the magnetizing electro-magnet 704A produces a magnetizing flux or force having an opposite polarity to that produced by magnetizing electro-magnet 704B.

In operation, rotor 701 is positioned within the dual rotor magnetizing assembly 702 such that two opposing rotor poles 116A and 116D having non-magnetized magnets 202A and 202D, respectively, are aligned with magnetizing electro-magnets 704A and 704B, respectively. The magnetizing windings 706A and 706D are energized at a level to produce a straight through magnetizing flux 710 between magnetizing electromagnets s 704A and 704B. As illustrated, straight through magnetizing flux 710 is produced between a south polarity magnetizing electro-magnet 704B that travels through the magnets 202D of rotor pole 116D, the arbor 505, the shaft 504, the magnets 202A of rotor pole 116A to magnetizing electromagnet 704A. The magnetizing flux 710 is generally applied along a magnetizing path 708 from the South polarity 709B to the North polarity 709A. The magnetizing path 708 is generally perpendicular to the surface and/or body of each of the block-shaped magnets 202. As such, each block magnet 202 receives substantially perpendicular magnetizing flux 710 across the entire width of the block magnet 202. Additionally, the magnetizing flux 710 has substantially consistent or equivalent density across the width of each magnet 202 and is generally equal in strength and density for each magnet 202 in each cavity 108 and layer of the magnetized poles 116 A and D.

The looping magnetizing flux 712 loops between magnetizing electro-magnet 704A to 704B through the body of the dual rotor magnetizing assembly 702 or through a gaseous medium surrounding the magnetizing assembly 702. This process simultaneously magnetizes the magnets 202 of two 180 degree opposing poles 116A and 116D with one pole being magnetized with a North polarity and the other being magnetized with a South polarity. After the two poles 116A and 116D are sufficiently magnetized, the rotor 701 and/or the dual rotor magnetizing assembly 702 can be rotated relatively to the other so that additional pairs of non-magnetized magnets 202 in the other 180 degree opposing rotor poles 116 can be magnetized. This process is repeated until all rotor poles 116 of rotor 701 are magnetized.

In another embodiment of the invention, an inner rotor having a plurality of non-magnetized magnets and a rotor cavity can have each of the rotor poles individually magnetizing. This is accomplished by positioning one portion of a magnetizing device within the rotor cavity and positioning a second portion of the magnetizing device external to the perimeter of the rotor. A magnetizing flux is applied between the two portions of the magnetizing device and to the non-magnetized magnets of the pole therebetween to magnetize the pole. The magnetizing flux can be a North polarity or South polarity magnetizing flux as may be desired to magnetize the particular pole appropriately. Each pole is individually magnetized by rotating the rotor within the single rotor pole magnetizing assembly or by rotating the single rotor pole magnetizing assembly around the rotor. The poles can be magnetized such that alternating North and South poles are defined on the rotor.

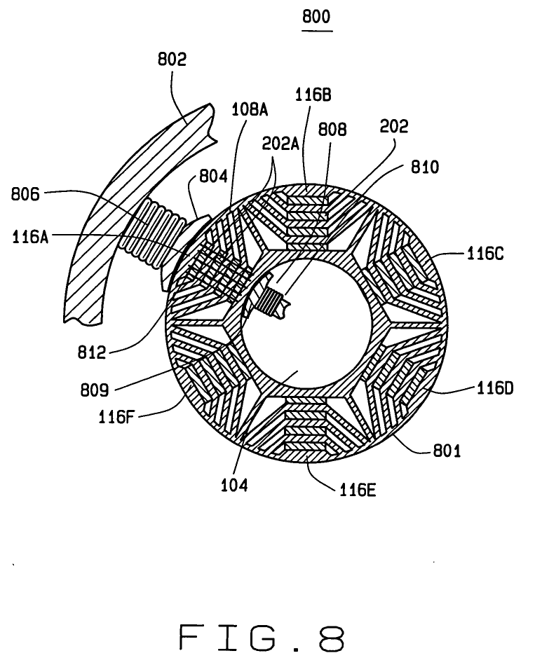

FIG. 8 illustrates a single pole magnetizing assembly 800 according to one exemplary embodiment of the invention. As illustrated, a rotor assembly 801 includes a plurality of rotor poles 116A-F. Each rotor pole includes cavities 108 with non-magnetized magnets 202 positioned therein. In one preferred embodiment, magnets 202 have a block shape and are substantially dimensioned the same in each cavity 108 of a rotor pole 116. An arbor cavity 104 is defined by the rotor 801 and is dimensioned to accept at least a portion of a magnetizing magnet. A single rotor pole magnetizing assembly 802 includes an inner magnetizing electro-magnet 809 and an outer magnetizing electromagnet 804. The inner magnetizing electromagnet 809 is magnetically and electrically coupled to the outer magnetizing electro-magnet 804 through a coupling (not shown) of single rotor magnetizing assembly 802 via inner magnet return assembly 810. Such coupling provides for the desired magnetic looping of the magnetic flux between the two magnetizing electro-magnets 804 and 809. Each of the inner and outer magnetizing electromagnets 804 and 809 are dimensioned such that a consistent magnetizing force or flux is applied across the substantial length of rotor 801 and substantial length of magnets 202.

The inner magnetizing electro-magnet 809 includes inner magnetizing wire or windings 808 and the outer magnetizing electromagnet 804 includes outer magnetizing wire or windings 806. When energized, the wire windings 806 and 808 produce a magnetizing force or flux 812 for magnetizing the magnets 202 of a single rotor pole 116. The energy applied to the wire windings 806 and 808 can be varied to produce either a North or South polarity to rotor pole 116.

The magnetizing flux 812 is generally applied perpendicular to the surface and/or body of each of the block-shaped magnets 202. As such, each block magnet 202 receives substantially perpendicular magnetizing flux 812 across the entire width of the block magnet 202. Additionally, the magnetizing flux 812 has substantially consistent or equivalent density across the width of each magnet 202 and is generally equal in strength and density for each magnet 202 in each cavity 108 and layer of the magnetized pole 116A.

After magnetization of the magnets 202A of rotor pole 116A, either the rotor 801 or the single rotor pole magnetization assembly 802 is rotated such that each rotor pole 116 is positioned between inner and outer magnetizing electromagnets 804 and 809. Each rotor pole 116 is magnetized as desired as either a North or South polarity rotor pole.

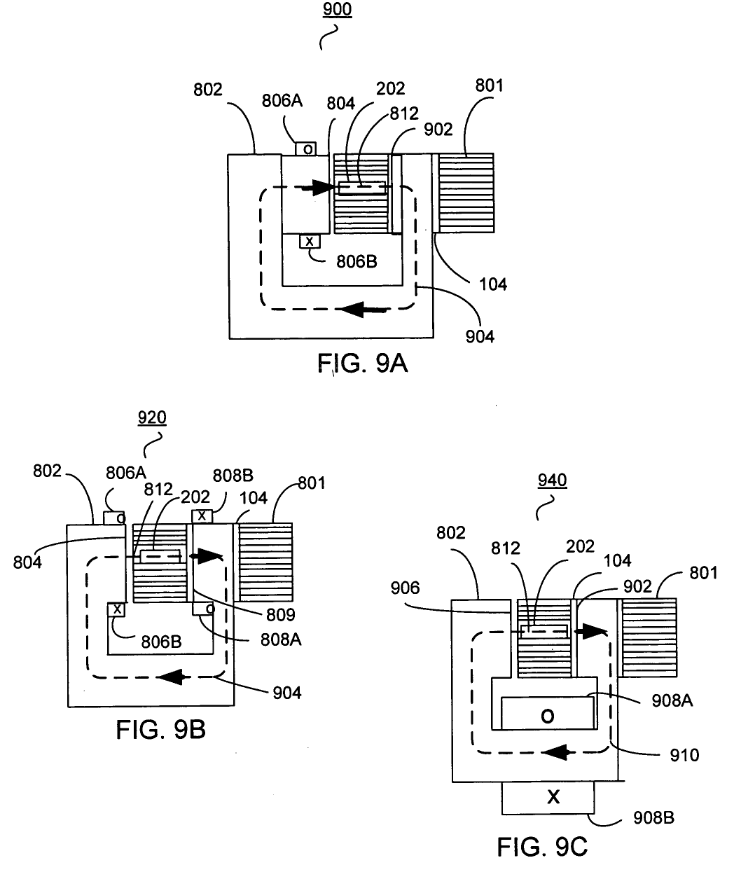

FIGS. 9A, 9B, and 9C illustrate three exemplary embodiments of a single pole magnetizing assembly for a rotor 801 containing non-magnetized magnets 202.

In one embodiment, a single pole magnetizing assembly includes a single electromagnet for magnetizing the non-magnetized magnets of a single rotor pole. As illustrated in FIG. 9A, a magnetizing system 900 includes a single pole magnetizing assembly 802 having an outer magnetizing electro-magnet 804 and a flux arm 902 positioned with the center cavity or arbor 104 of the rotor 801. The flux arm 902 does not include a winding and is therefore a passive return path for the flux. The rotor 801 is positioned such that non-magnetized magnet 202 of a single rotor pole is positioned substantially between the outer electromagnet 804 and passive flux arm 902. When windings 806 (represented as 806A and 806B) receive an activating energy from an external energy source (not shown), magnetizing electromagnet 804 generates magnetizing force or flux 812 through magnet 202 to magnetize magnet 202. The magnetizing force 812 may be either a North or a South magnetizing polarity. The magnetizing flux 812 is received by flux arm 902 and is looped by single pole magnetizing assembly 802 as looping flux 904. The rotor 801 is rotated about the flux arm 902 of the magnetizing assembly 802 so that each set of non-magnetized magnets 202 of each pole of the rotor 801 is magnetized either as a North or South polarity.

In another embodiment, a single pole magnetizing assembly has two electromagnets as briefly introduced above with regard to FIG. 8. A two electro-magnet single pole magnetizing system 920 is illustrated in FIG. 9B. Magnetizing assembly 802 includes an outer magnetizing electromagnet 804 with outer windings 806 (illustrated as 806A and 806B) and inner magnetizing electromagnet 809 with inner windings 808 (illustrated as 808A and 808B). The rotor 801 is positioned about magnetizing assembly 802 such that non-magnetized magnet 202 of a single pole of the rotor 801 is positioned between the outer and inner magnetizing electro-magnets 804 and 809. A magnetizing force 812 is generated through magnets 202 and between the outer and inner magnetizing electromagnets 804 and 809 when the windings 806 and 808 receive a magnetizing energy from an external energy source (not shown). The magnetizing force 812 may be either a North or a South magnetizing polarity. A looping flux 904 is generated and looped through assembly 802. The rotor 801 is rotated about the inner magnetizing electro-magnet 809 of the magnetizing assembly 802 so that each set of non-magnetized magnets 202 of each pole of the rotor 801 is magnetized either as a North or South polarity.

Another embodiment of a single pole magnetizing assembly having a single electromagnet is illustrated in FIG. 9C. A magnetizing system 940 includes a magnetizing assembly 802 having a single electro-magnet winding 908 (illustrated as 908A and 908B) and two magnetizing arms 902 and 906. The winding 908 is positioned about magnetizing assembly 802 to induce a circulating magnetic flux 910 within magnetizing assembly and between the two magnetizing arms 906 and 902. The rotor 801 is positioned about inner magnetizing arm 902 such that the inner magnetizing arm 902 is position within arbor 104 and non-magnetized magnet 202 is positioned between the outer and inner magnetizing arms 906 and 902. When winding 908 receives a magnetizing energy from an external energy source (not shown), circulating magnetic flux 910 is generated in assembly 802 and as magnetizing force 812 between the outer and inner magnetizing arms 906 and 902. The magnetizing force 812 may be either a North or a South magnetizing polarity. The rotor 801 is rotated about the passive flux arm 902 of the magnetizing assembly 802 so that each set of non-magnetized magnets 202 of each pole of the rotor 801 is magnetized either as a North or South polarity.

One or more embodiments of the invention as described herein provides a rotor design and method of magnetizing a rotor for an electric machine that provides for improved performance and/or reduced cost in manufacturing a rotor.

When introducing embodiments and aspects of the invention, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several advantages are achieved and other advantageous results attained by the various embodiments of the invention. As various changes could be made in the above exemplary constructions and methods without departing from the scope of the invention, it is intended that all matter contained in the above description or shown in the accompanying drawings shall be interpreted as illustrative and not in a limiting sense.

It is further to be understood that the steps described herein are not to be construed as necessarily requiring their performance in the particular order discussed or illustrated. It is also to be understood that additional or alternative steps may be employed.

1. A rotor for an electric machine, the rotor comprising a rotor core having a plurality of poles, at least one of the poles including at least three cavities spaced radially from one another, each cavity including a magnet portion, and a plurality of block magnets having substantially the same width, each block magnet positioned within one of the magnet portions of said cavities.

2. The rotor of claim 1 wherein the magnet portions are rectangular and the block magnets are dimensioned for insertion into the magnet portions.

3. The rotor of claim 1 wherein each of the plurality of block magnets has substantially the same dimensions.

4. The rotor of claim 1 wherein each cavity includes two flux barriers positioned on opposite sides of the magnet portion.

5. The rotor of claim 4 wherein each flux barrier extends from the magnet portion to about a perimeter of the rotor core.

6. The rotor of claim 1 wherein each pole has at least three cavities spaced radially from one another and each cavity includes a magnet portion with at least one block magnet positioned therein.

7. The rotor of claim 1 wherein the block magnets are magnetized magnets.

8. The rotor of claim 7 wherein the plurality of poles includes alternating North and South poles, each of the poles having a pole of opposite polarity positioned at 180 degrees.

9. The rotor of claim 7 wherein the block magnets have substantially uniform flux density.

10. The rotor of claim 7 wherein the block magnets of a pole have flux lines that are about parallel to a common radius extending from a center axis of the rotor core.

11. The rotor of claim 1 wherein at least one magnet portion has a plurality of block magnets positioned therein.

12. The rotor of claim 1 wherein the rotor core includes a plurality of laminated plates.

13. The rotor of claim 1 wherein the rotor core includes a plurality of poles equal to a sum of two plus a product of four times N, with N being an integer equal to or greater than one.

14. The rotor of claim 1 wherein the at least one pole includes at least four cavities spaced radially from one another and each cavity includes a magnet portion with at least one block magnet positioned therein.

15. The rotor of claim 1 wherein the magnet positioned within at least one cavity includes a plurality of magnet segments separated by an insulating material.

16. An electric machine comprising a shaft, a stator having a plurality of stator poles surrounding a rotor cavity, and a rotor attached to the shaft and positioned within the rotor cavity, said rotor having a rotor core with a plurality of poles equal to a sum of two plus a product of four times N, with N being an integer equal to or greater than one, each of said poles including a plurality of pole cavities spaced radially from one another, each cavity having a magnet portion, and a plurality of block magnets having substantially the same width, each cavity having at least one block magnet positioned within the magnet portion.

17. The electric machine of claim 16 wherein each rotor cavity includes two flux barriers positioned on opposite sides of the magnet portion, and each flux barrier extends from the magnet portion to about a perimeter of the rotor core.

18. The electric machine of claim 16 wherein each pole includes at least three cavities spaced radially from one another and each cavity includes a magnet portion with at least one block magnet positioned therein.

19. The electric machine of claim 16 wherein a magnet positioned in an outer cavity of the plurality of radially spaced cavities includes a plurality of magnet segments separated by an insulating material.

20-26. (canceled)

27. The rotor of claim 6 wherein each pole has at least four cavities spaced radially from one another and each cavity includes a magnet portion with at least one block magnet positioned therein.

28. The rotor of claim 18 wherein each pole includes at least four cavities spaced radially from one another and each cavity includes a magnet portion with at least one block magnet positioned therein.
